(19) United States
(12) Patent Application Publication
(10) Pub. No.: US 2018/0309340 A1
(43) Pub. Date: Oct. 25, 2018

(54) MOTOR

(71) Applicant: Nidec Corporation, Kyoto (JP)

(72) Inventors: Kosuke OGAWA, Kyoto (JP); Takashi HATTORI, Kyoto (JP)

(21) Appl. No.: 15/765,289

(22) PCT Filed: Oct. 12, 2016
(86) PCT No.: PCT/JP2016/080156

§ 371 Date: Apr. 2, 2018

(30) Foreign Application Priority Data
Oct. 14, 2015 (JP) 2015-202692

(51) Int. Cl. H02K 3/50; H02K 3/28; H02K 5/16; H02K 11/33; H02K 11/00; H02K 5/22

(52) U.S. Cl. CPC H02K 3/50; H02K 3/28; H02K 5/16; H02K 5/15; H02K 11/0094; H02K 5/22; H02K 2203/09; H02K 11/33

(57) ABSTRACT

A motor includes a rotor that includes a shaft centered on a central axis extending in an upward and downward direction; a stator that is positioned to face the rotor; and a bus bar unit that is positioned on an upper side of the stator and connects the stator to a control device. The bus bar unit includes a bus bar and a bus bar holder supporting the bus bar. The bus bar includes a coil connecting portion that is connected to a coil end extending from the stator, a connecting terminal portion that extends upward and is connected to the control device, a support portion that is supported by the bus bar holder, and an arm portion that is positioned between the support portion and the connecting terminal portion. The arm portion extends in a direction intersecting a radial direction in plan view.

### BACKGROUND OF THE INVENTION

### 1. Field of the Invention

The present disclosure relates to a motor.

### 2. Description of the Related Art

There is known a motor in which a motor case that accommodates the motor and an accommodating member that accommodates a controller are coupled and integrated. Such a motor has a connecting terminal portion extending to a controller side and is connected to the controller by inserting the connecting terminal portion into a socket provided in the controller.

In a state where the connecting terminal portion of the motor and the socket of the controller are connected to each other, a positional deviation may occur due to an influence of thermal expansion or the like. In a case where the connecting terminal portion is immovably fixed to the motor, there is a concern that a connection state is unstable due to the relative positional deviation between the connecting terminal portion and the socket.

### SUMMARY OF THE INVENTION

A motor according to a preferred embodiment of the present invention includes a rotor that includes a shaft centered on a central axis extending in an axial direction; a stator that is positioned to face the rotor; and a bus bar assembly that is positioned on an axially upper side of the stator and connects the stator to a controller. The bus bar assembly includes a bus bar and a bus bar holder supporting the bus bar. The bus bar includes a coil connecting portion that is connected to a coil end extending from the stator, a connecting terminal portion that extends axially upward and is connected to the controller, a support portion that is supported by the bus bar holder, and an arm portion that is positioned between the support portion and the connecting terminal portion. The arm portion extends in a direction intersecting a radial direction in plan view.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a sectional view illustrating a motor according to a preferred embodiment of the present invention.

FIG. 2 is a perspective view of the motor according to a preferred embodiment of the present invention in which a housing is omitted.

FIG. 3 is an exploded perspective view of a bus bar assembly according to a preferred embodiment of the present invention.

FIG. 4 is a plan view of the bus bar assembly according to a preferred embodiment of the present invention.

FIG. 5 is a schematic plan view of a state where a first bus bar according to a preferred embodiment of the present invention is unfolded.

FIG. 6 is a schematic plan view of a state where a second bus bar according to a preferred embodiment of the present invention is unfolded.

FIG. 7 is a plan view of a bus bar assembly according to Modification example 1 of a preferred embodiment of the present invention.

FIG. 8 is a perspective view of a bus bar assembly according to Modification example 2 of a preferred embodiment of the present invention.

### DETAILED DESCRIPTION OF THE PREFERRED EMBODIMENTS

Hereinafter, preferred embodiments of the present disclosure will be described with reference to the drawings.

In the following description, a direction in which a central axis J extends is an upward and downward direction. However, the upward and downward direction in the present specification is simply a name used for explanation and does not limit an actual positional relationship and direction of the device with respect to gravity upon installation. In addition, unless otherwise specified, a direction parallel to the central axis J is simply referred to as an “axial direction”, a radial direction centered on the central axis J is simply referred to as a “radial direction”, and a circumferential direction centered on the central axis J (centered on the axis of the central axis J) is simply referred to as a “circumferential direction”.

Moreover, in the present specification, the term extending in the axial direction includes not only a case of strictly extending in the axial direction but also includes a case of extending in a direction inclined in a range of less than about 45 degrees with respect to the axial direction. Moreover, in the present specification, the term extending in the radial direction includes not only a case of strictly extending in the radial direction, that is, extending in a direction perpendicular to the axial direction but also includes a case of extending in a direction inclined in a range of less than about 45 degrees with respect to the radial direction.

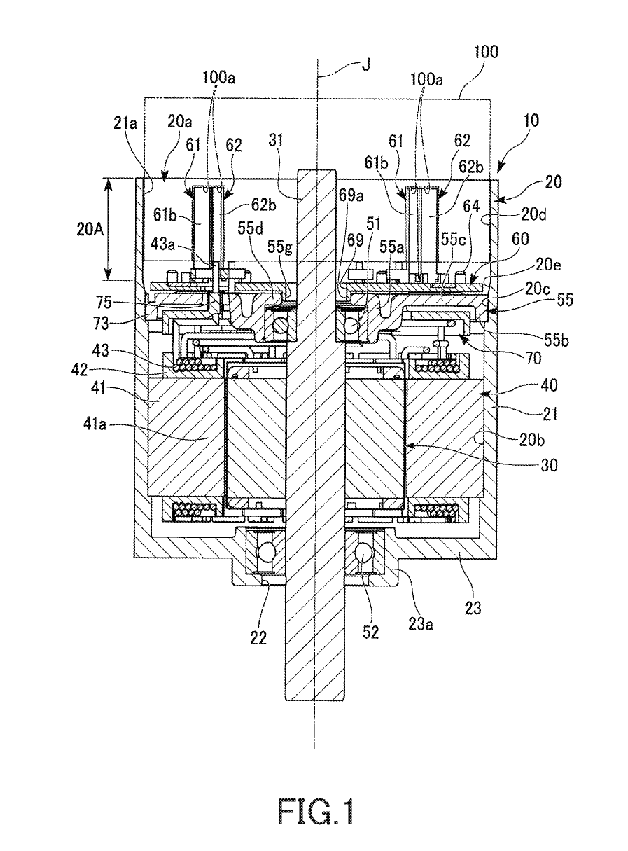

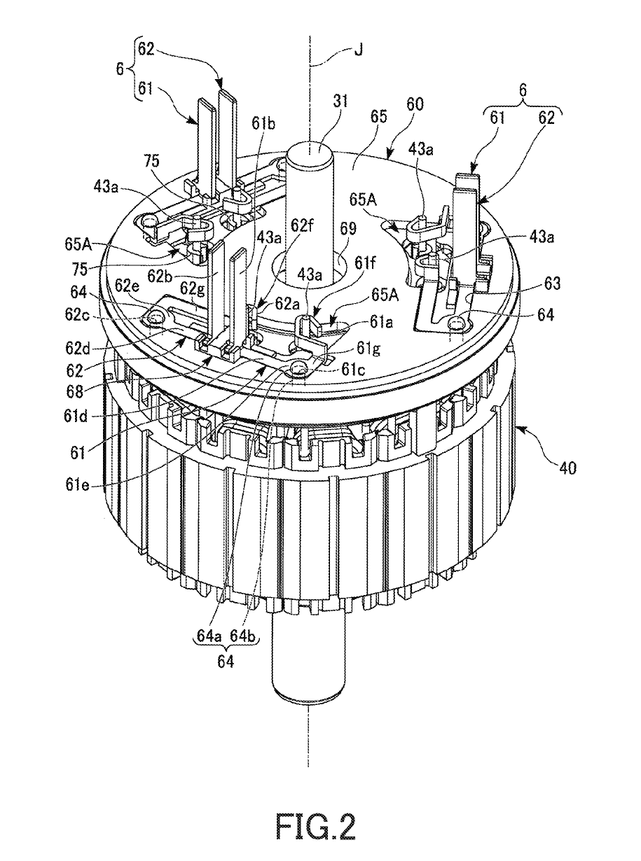

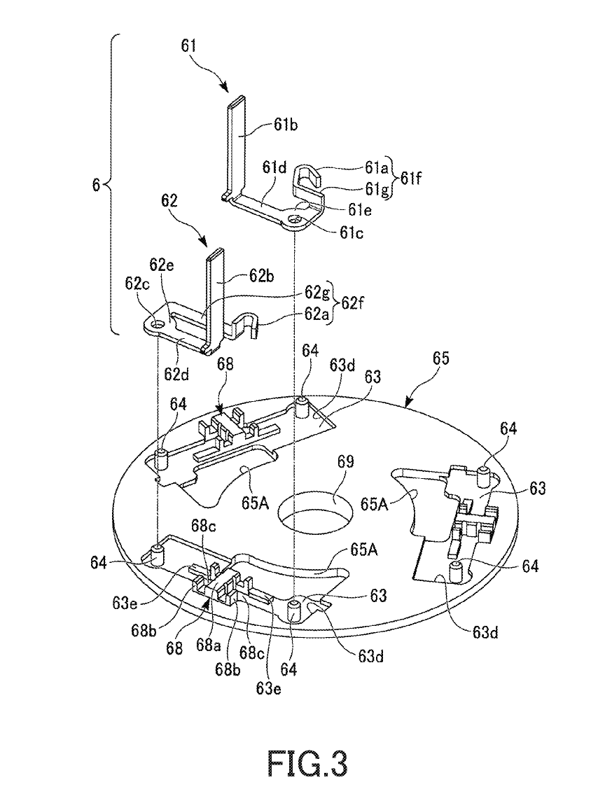

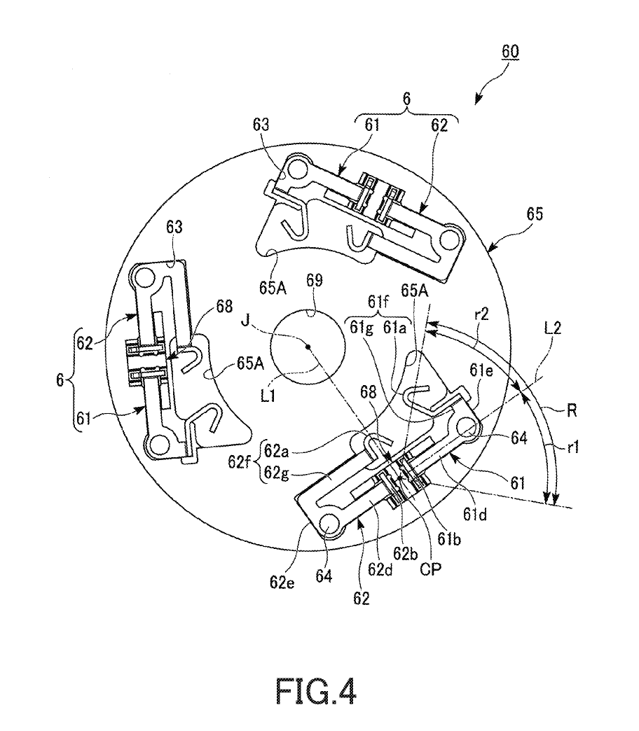

FIG. 1 is a sectional view illustrating a motor 10 according to a preferred embodiment of the present invention. FIG. 2 is a perspective view of the motor 10 in which a housing 20 is omitted. FIG. 3 is an exploded perspective view of a bus bar assembly 60. FIG. 4 is a plan view of the bus bar assembly 60.

The motor 10 preferably includes the cylindrical housing 20 having an opening on an upper side, a rotor 30, a stator 40, a wire support member 70, a bearing holder 55, an upper bearing 51, a lower bearing 52, and the bus bar assembly 60. The bus bar assembly 60, the bearing holder 55, the wire support member 70, and the stator 40 are arranged in this order from the upper side to the lower side in the motor 10. The motor 10 includes a controller accommodating region 20A capable of accommodating at least a portion of a controller 100 on the upper side of the bus bar assembly 60. That is, the bus bar assembly 60 is positioned on the lower side of the controller accommodating region 20A. The controller 100 includes a socket 100a into which connecting terminal portions 61b and 62b extending from the bus bar assembly 60 to the upper side are inserted to be connected. The controller accommodating region 20A is provided on the upper side of the bus bar assembly 60 so that the controller 100 is guided by an inner peripheral surface of the housing 20 in the axial direction to smoothly connect the connecting terminal portions 61b and 62b, and the socket 100a.

The housing 20 preferably includes a cylinder portion 21 extending in the upward and downward direction, a bottom wall portion 23 positioned at a lower end of the cylinder portion 21, and an opening portion 20a opened to the upper side. The stator 40 and the bearing holder 55 are accommodated and fixed to an inner surface of the housing 20 in order from the lower side.

The cylinder portion 21 has a cylindrical shape centered on the central axis J. The cylinder portion 21 preferably includes an inner peripheral surface 20b that holds the stator 40, an inner peripheral surface 20c that holds the bearing holder 55, and an inner peripheral surface 20d of the controller accommodating region 20A that accommodates a portion of the controller 100. An inner diameter of the inner peripheral surface 20d is larger than an inner diameter of the inner peripheral surface 20c. The inner diameter of the inner peripheral surface 20c is larger than an inner diameter of the inner peripheral surface 20b. That is, the housing 20 has an inner surface shape in which the inner diameter decreases from the opening portion 20a toward a back side (bottom wall portion 23 side).

The housing 20 preferably includes an inclined surface 20e that connects the inner peripheral surface 20c and the inner peripheral surface 20d having different the inner diameters. A surface shape of the inclined surface 20e has a smaller inner diameter as it goes to the lower side in the axial direction. That is, it is preferable that a cross-sectional shape of the inclined surface 20e is linear or curved. Therefore, an assembling operator or the like (assembling operator, assembling device, or the like) can smoothly dispose the bearing holder 55 inserted from the opening portion 20a to an attachment position (inner peripheral surface 20c).

Moreover, the housing 20 may not necessarily have the inclined surface 20e. For example, the housing 20 may have a configuration in which the inner peripheral surface 20c and the inner peripheral surface 20d are connected via a stepped portion in the axial direction.

The shape of the cylinder portion 21 is not limited to the cylindrical shape. An outer shape of the cylinder portion 21 may be, for example, a box shape as long as the cylinder portion 21 has a shape capable of holding the stator 40 and the bearing holder 55 on the inner peripheral surface. In addition, the outer shape of the cylinder portion 21 may be a combination of the cylindrical shape and the box shape. The stator 40 or the bearing holder 55 may be held at a portion of the inner surface of the cylinder portion 21 in the axial direction.

The bottom wall portion 23 preferably includes a bearing holding portion 23a that is disposed on the lower side of the stator 40 and holds the lower bearing 52, and an output shaft hole that penetrates the bottom wall portion 23 in the axial direction.

The rotor 30 includes a shaft 31. The shaft 31 is centered on the central axis J extending in the upward and downward direction. The rotor 30 rotates around the central axis J together with the shaft 31. An end portion of the shaft 31 on the lower side protrudes to the lower side of the housing 20 via the output shaft hole 22.

The upper bearing 51 and the lower bearing 52 support the shaft 31 so as to be rotatable around the central axis. The lower bearing 52 is held by the bearing holding portion 23a on the lower side of the stator 40. The upper bearing 51 is held by the bearing holder 55 on the upper side of the stator 40.

The stator 40 is positioned on an outside of the rotor 30 in the radial direction and faces the rotor 30. The stator 40 preferably includes a stator core 41, an insulator 42, and a coil 43. The insulator 42 is attached to teeth 41a of the stator core 41. The coil 43 is defined by a conductor wound around the insulator 42 and is disposed on each of the teeth 41a. The outer peripheral surface of the stator 40 is fixed to the inner peripheral surface 20b of the housing 20.

As illustrated in FIG. 1, the wire support member 70 is disposed on the stator 40. The wire support member 70 preferably includes a disc-shaped main body 73 in which a hole through which the shaft 31 passes at a center, a plurality of wire support portions 75 that protrude upward from the main body 73, and a neutral point bus bar (not illustrated) to which a neutral point of the coil is connected. As illustrated in FIG. 2, the wire support portion 75 includes a U shape opening to the inside in the radial direction in plan view, and surrounds a coil lead wire, which extends from the stator 40 to the upper side and is connected to phase bus bars (hereinafter, referred to as bus bars) 61 and 62, from an outer periphery to support the coil lead wire.

The bearing holder 55 has a disc shape or approximate disc shape and is disposed on the upper side of the stator 40 and on the lower side of the bus bar assembly 60. The bearing holder 55 holds the upper bearing 51. As illustrated in FIG. 1, the bearing holder 55 preferably includes an inner cylinder portion 55a that holds the upper bearing 51, an upper edge portion 55d that extends from an upper end of the inner cylinder portion 55a to the inside in the radial direction, an outer cylinder portion 55b that is fitted to the inner peripheral surface 20b of the housing 20, and a coupling portion 55c that couples the inner cylinder portion 55a and the outer cylinder portion 55b. The upper edge portion 55d is provided with a bearing holder through-hole 55g through which the shaft 31 passes. That is, the bearing holder 55 is provided with the bearing holder through-hole 55g through which the shaft 31 passes.

It is preferable that a linear expansion coefficient of a material configuring the bearing holder 55 is equal or substantially equal to a linear expansion coefficient of a material configuring the housing 20. With the configuration, since expansion amounts and contraction amounts of the housing 20 and the bearing holder 55 are equal or substantially equal to each other with respect to a temperature change after the bearing holder 55 is assembled to the housing 20, the attachment of the bearing holder 55 is unlikely to be loosened. In a case of the present preferred embodiment, the bearing holder 55 and the housing 20 are preferably both made of aluminum or an aluminum alloy, for example. Moreover, the bearing holder 55 and the housing 20 may be made of materials other than the above.

The bus bar assembly 60 is positioned on the upper side of the stator 40 and connects the stator 40 to the controller 100. The bus bar assembly 60 has a plurality (for example, six in the present preferred embodiment) of the bus bars (first bus bars 61 and the second bus bar 62), and a bus bar holder 65 that is made of a resin material as an electrically insulating material and supports the bus bars 61 and 62. The plurality of the bus bars include the first bus bars 61 and the second bus bars 62 having different shapes each other. That is, the bus bar assembly 60 preferably includes three first bus bars 61 and three second bus bars 62. In addition, the first bus bar 61 and the second bus bar 62 are disposed on the upper surface of the bus bar holder 65 as a pair. In the following description, the pair of the first bus bar 61 and the second bus bar 62 is referred to as a bus bar pair 6. The bus bar assembly 60 of the preferred embodiment has three bus bar pairs 6.

Next, each portion of the first bus bar 61 and the second bus bar 62 will be described with reference to FIG. 3. Moreover, for the configuration common to each portion of the first bus bar 61 and the second bus bar 62, the description of the second bus bar 62 will be represented by the description of the first bus bar 61 and the description of the second bus bar 62 will be omitted.

The first bus bar 61 preferably includes a coil connecting portion 61f, a connecting terminal portion 61b, a support portion 61e, and an arm portion 61d. Similarly, the second bus bar 62 includes a coil connecting portion 62f, a connecting terminal portion 62b, a support portion 62e, and an arm portion 62d. The coil connecting portions 61f and 62f include terminals 61a and 62a, and the coupling portions 61g and 62g. The coil connecting portions 61f and 62f are connected to a coil end 43a extending from the stator 40 in the terminals 61a and 62a. The coupling portions 61g and 62g are positioned between the support portions 61e and 62e, and the terminals 61a and 62a. The connecting terminal portions 61b and 62b extend upward and is connected to the controller 100. The support portions 61e and 62e are supported by the bus bar holder 65. The arm portions 61d and 62d are positioned between the support portions 61e and 62e, and the connecting terminal portions 61b and 62b.

The first bus bar 61 and the second bus bar 62 are preferably formed by bending a metal plate member, for example. Each portion of the first bus bar 61 and the second bus bar 62 has a flat plate shape having the same plate thickness. The coil connecting portions 61f and 62f, and the connecting terminal portions 61b and 62b, are respectively positioned at both end portions of the bus bars 61 and 62. In the terminals 61a and 62a of the coil connecting portions 61f and 62f, and the connecting terminal portions 61b and 62b, the plate thickness direction is perpendicular or substantially perpendicular to the axial direction. On the other hand, in the arm portions 61d and 62d, the support portions 61e and 62e, and the coupling portions 61g and 62g of the coil connecting portions 61f and 62f, the plate thickness direction coincides with the axial direction.

The coil connecting portion 61f is positioned on the inside with respect to the support portion 61e in the radial direction. The terminal 61a of the coil connecting portion 61f has a U shape opening to the outside in the radial direction in plan view. The terminal 61a grips the coil end 43a in the opening and is electrically connected to the coil end 43a. The terminal 61a is connected to the coil end 43a, for example, by resistance welding.

As illustrated in FIG. 4, the coil connecting portion 61f overlaps the arm portion 61d in the radial direction. Here, the coil connecting portion 61f is preferably positioned on the inside in the radial direction or on the outside with respect to the arm portion 61d in the radial direction, and the position of the coil connecting portion 61f in the axial direction may be offset from the position of the arm portion 61d in the axial direction. As described later, the arm portion 61d extends to intersect with the radial direction in plan view. Therefore, a space is provided on the inside of the arm portion 61d in the radial direction (or outside in the radial direction). The coil connecting portion 61f is disposed at a position overlapping the arm portion 61d in the radial direction so that the space on the inside of the arm portion 61d in the radial direction (or outside in the radial direction). Therefore, it is possible to reduce a dimension of the bus bar assembly in the radial direction and to make the bus bar assembly compact. Moreover, in a case where the positions of the coil connecting portion 61f and the arm portion 61d are coincident with each other in the radial direction, it is possible to reduce a dimension of the bus bar assembly 60 in the radial direction and to make the bus bar assembly compact in the axial direction compared to a case where they are not coincident with each other.

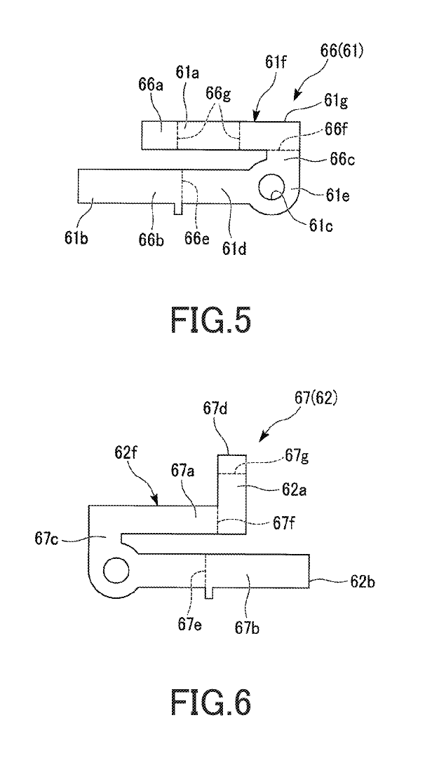

In addition, the coil connecting portion 61f is preferably disposed at a position overlapping the arm portion 61d in the radial direction so that it is possible to make the shape of the first bus bar 61 be a U shape in plan view. Therefore, as described later with reference to FIG. 5, a first metal plate 66 of a state where the first bus bar 61 is unfolded can also have a U shape. Therefore, in a case where the first metal plate 66 is molded by punching, it is possible to secure a larger number of plate materials as a material and to reduce the manufacturing cost.

As illustrated in FIG. 4, in the first bus bar 61, only a portion of the terminal 61a of the coil connecting portion 61f overlaps the arm portion 61d in the radial direction. On the other hand, in the second bus bar 62, the coupling portion 62g of the coil connecting portion 62f overlaps the arm portion 62d and does not overlap the terminal 61a in the radial direction. As described above, even if the coil connecting portions 61f and 62f partially overlap the arm portions 61d and 62d in the radial direction, it is possible to obtain the effect described above.

The connecting terminal portion 61b has a rectangular shape and extends from the arm portion 61d to the upper side. The connecting terminal portion 61b is inserted into the socket 100a provided in the controller 100 and configures a connecting portion between the motor 10 and the controller 100. A width (dimension on a lateral direction) of the connecting terminal portion 61b is larger than a width of the arm portion 61d at least at a base portion. The connecting terminal portion 61b is accommodated in a connecting terminal accommodating portion 68 provided in the bus bar holder 65.

As illustrated in FIG. 3, the connecting terminal accommodating portion 68 is preferably defined by a central protruding portion 68a and side protruding portions 68b that are provided on both sides of the central protruding portion 68a at a distance equal or substantially equal to the plate thickness of the first and second bus bars 61 and 62. The side protruding portion 68b is provided with a notch 68c. The connecting terminal portions 61b and 62b are accommodated by the central protruding portion 68a and the side protruding portions 68b. End portions of the arm portions 61d and 62d pass through the notches 68c. A gap width between the central protruding portion 68a and the side protruding portion 68b is larger than the plate thickness of the bus bars 61 and 62. A notch width of the notch 68c is larger than a width dimension of the arm portions 61d and 62d. That is, the connecting terminal accommodating portion 68 movably accommodates the bus bars 61 and 62. Therefore, the connecting terminal accommodating portion 68 significantly reduces or prevents falling of the connecting terminal portions 61b and 62b when the connecting terminal portions 61b and 62b are inserted into the socket 100a of the controller 100.

The support portion 61e is preferably provided with a hole 61c penetrating in the upward and downward direction. A support protrusion 64 extending from the upper surface of the bus bar holder 65 to the upper side is inserted into the hole 61c. Therefore, the bus bar holder 65 supports the first bus bar 61 at the support portion 61e.

As illustrated in FIG. 2, the support protrusion 64 of the bus bar holder 65 includes a shaft portion 64b and a head portion 64a. That is, the bus bar holder 65 has the shaft portion 64b and the head portion 64a. The shaft portion 64b extends from the upper surface of the bus bar holder 65 to the upper side. The head portion 64a is positioned at a tip of the shaft portion 64b on the upper side. A diameter of the head portion 64a is larger than a diameter of the shaft portion 64b. The head portion 64a is preferably molded by thermally welding the tip of the shaft portion 64b, for example. In a state before the head portion 64a is molded, the assembling operator or the like inserts the shaft portion 64b into the hole 61c provided at the support portion 61e of the first bus bar 61 and thermally welds the tip of the shaft portion 64b to mold the head portion 64a. The diameter of the hole 61c is larger than the diameter of the shaft portion 64b and is smaller than the diameter of the head portion 64a. Therefore, the support portion 61e is supported by the support protrusion 64 and is prevented from releasing upward. In addition, the shaft portion 64b is inserted into the hole 61c and then the head portion 64a is molded to the tip of the shaft portion 64b by thermal welding so that the support protrusion 64 can easily support the first bus bar 61. Therefore, it is possible to simplify an assembling step.

The first bus bar 61 preferably includes one support portion 61e. The support portion 61e is provided with one hole 61c into which the shaft portion 64b of the support protrusion 64 is inserted. Therefore, the first bus bar 61 is capable of rotating with respect to the bus bar holder 65 centered on the support portion 61e (more specifically, the hole 61c) in a plane perpendicular or substantially perpendicular to the central axis J. More specifically, the first bus bar 61 is capable of rotating with respect to the bus bar holder 65 centered on the hole 61c in the plane perpendicular or substantially perpendicular to the central axis J. When the connecting terminal portion 61b is inserted into the socket 100a of the controller 100 to be connected, even in a case where the socket 100a and the connecting terminal are relative positional shifted, the first bus bar 61 is able to be rotated according to the shift and the connecting terminal portion 61b is able to be smoothly inserted by making the first bus bar 61 rotatable with respect to the bus bar holder 65 centered on the support portion 61e. In addition, as described above, since the connecting terminal portion 61b is inserted, the first bus bar 61 is supported only by the support portion 61e on the bus bar holder 65 and the arm portion 61d can be electrically deformed

The first bus bar 61 is accommodated in a recessed portion 63 disposed on the upper surface of the bus bar holder 65. The recessed portion 63 preferably includes an inner wall 63d facing the outer peripheral surface of the first bus bar 61. The recessed portion 63 is provided with a projection wall 63e along an opening edge of a first through-hole 65A described below. The inner wall 63d and the projection wall 63e limit the rotation of the first bus bar 61. That is, the bus bar holder 65 includes a rotation limiting portion (that is, the inner wall 63d and the projection wall 63e) that limits the rotation of the first bus bar 61 centered on the support portion 61e. In addition, a wall facing notch 68c of the connecting terminal accommodating portion 68 also acts simultaneously as the rotation limiting portion that limits the rotation of the first bus bar 61. Since the rotation of the first bus bar 61 is limited in a predetermined angle range by the rotation limiting portion, the first bus bar 61 does not excessively rotate and it is possible to prevent deterioration in assembly property due to the rotation. In addition, a side surface of the first bus bar 61 is supported on the bus bar holder 65 while abutting against at least a portion of the rotation limiting portion, so that it is possible to align the first bus bar 61 with respect to the bus bar holder 65.

Moreover, the rotation limiting portion is not limited to the configuration of the present preferred embodiment, but, for example, may be a projection that is disposed around the first bus bar 61 and projects from the upper surface of the bus bar holder 65 to the upper side in the axial direction.

As illustrated in FIG. 4, the arm portion 61d preferably extends in a direction perpendicular or substantially perpendicular to the radial direction in plan view. That is, the arm portion 61d extends in a direction intersecting in the radial direction in plan view. However, the direction in which the arm portion 61d extends is not limited to the direction perpendicular or substantially perpendicular to the radial direction in plan view, but may be changed in a predetermined angle range R. The predetermined angle range R is defined as follows. In FIG. 4, a first reference line L1, which connects an intermediate point CP that is positioned between the connecting terminal portion 61b and the connecting terminal portion 62b in plan view and the central axis J, is assumed. Next, a second reference line L2 which is perpendicular or substantially perpendicular to the first reference line L1 and passes through the connecting terminal portion 61b, is assumed. In the present preferred embodiment, the arm portion 61d extends along the second reference line L2. The predetermined angle range R is defined by a predetermined angle range r1 in the clockwise direction and a predetermined angle range r2 in the counterclockwise direction from the second reference line L2 based on the intermediate point CP as a starting point. For example, the predetermined angle range r1 is about +45 degrees and the predetermined angle range r2 is about −45 degrees (that is, the predetermined angle range R is about ±45 degrees from the second reference line L2). More specifically, it will be described in Modification example 1.

Moreover, in a case where the direction of the arm portion 61d is changed in the angle range R, as necessary, in the configuration of FIG. 4, a change, such as increasing the outer diameter of the bus bar holder 65, moving the first bus bar on the inside in the radial direction, or moving the first through-hole 65A and the coil end 43a on the inside in the radial direction, can be performed.

The arm portion 61d is preferably disposed so as to extend in a direction intersecting the radial direction in plan view so that it is possible to lengthen the arm portion 61d without increasing the dimension of the bus bar assembly 60 in the radial direction compared to a structure in which the arm portion extends in the radial direction. An amount of deformation of the arm portion 61d due to deflection of one end portion with respect to the other end portion increases in proportion to a length in a longitudinal direction. Therefore, in the first bus bar 61, the deformation of the arm portion 61d with the support portion 61e as a fulcrum is easily performed and the arm portion 61d is likely to bend and deform in the upward and downward direction by lengthening the arm portion 61d in the longitudinal direction. Therefore, the connecting terminal portion 61b is able to easily move upward. In addition, a twist deformation of the arm portion 61d with respect to the longitudinal direction is easily performed by lengthening the arm portion 61d in the longitudinal direction. Therefore, a tip side of the connecting terminal portion 61b is able to easily move in a falling direction with a base side as the starting point.

In addition, in a state where the connecting terminal portion 61b is connected to the socket 100a of the controller 100, there is a case where a relative positional relationship between the socket 100a and the connecting terminal portion 61b is changed due to the thermal expansion (for example, the connecting terminal portion 61b is pulled upward by the socket 100a). Also in this case, the connecting terminal portion 61b is able to be moved by the deformation of the arm portion 61d to absorb the change in the relative positional relationship and to suppress that the connection becomes unstable. In addition, the connecting terminal portion 61b is movable so that, for example, the tip falls down in the radial direction with the base portion as the starting point. Therefore, even if the position of the connecting terminal portion 61b does not accurately coincide with the socket 100a, it is possible to smoothly insert the connecting terminal portion 61b into the socket 100a of the controller 100. Therefore, it is possible to enhance the ease of assembling the motor 10 and the controller 100.

As illustrated in FIG. 4, the first bus bar 61 and the second bus bar 62 of the bus bar pair 6 are disposed such that the arm portions 61d and 62d are linearly arranged in a plane perpendicular or substantially perpendicular to the axial direction. Three sets of the bus bar pairs 6 are disposed adjacent to each other at equal or substantially equal intervals in the circumferential direction. Therefore, it is easy to compactly dispose the three bus bar pairs 6 and it is possible to effectively utilize the space in a plane perpendicular or substantially perpendicular to the axial direction of the bus bar assembly 60.

The bus bar holder 65 has a disc shape and is fixed to the upper surface of the bearing holder 55. Three recessed portions 63 are provided on the upper surface of the bus bar holder 65. The recessed portions 63 accommodate the bus bar pair 6 respectively. The bus bar holder 65 includes the support projection 64 positioned on the inside of the recessed portion 63, the connecting terminal accommodating portion 68, and the projection wall 63e, and supports the bus bars 61 and 62 on the inside of the recessed portion 63.

FIGS. 5 and 6 are respectively schematic plan views of a state where the first bus bar 61 and the second bus bar 62 are unfolded. The first bus bar 61 is preferably made of the first metal plate 66 bent in the thickness direction. Similarly, the second bus bar 62 is preferably made of a second metal plate 67 bent in the thickness direction.

As illustrated in FIG. 5, the first bus bar 61 includes a base end portion 66c, a first linear portion 66a, and a second linear portion 66b respectively extending from the base end portion 66c in the same direction in a state of being unfolded (that is, the first metal plate 66). Therefore, the first metal plate 66 has a U shape or approximate U-shape, for example.

At the first linear portion 66a, the coil connecting portion 61f is positioned. That is, the coil connecting portion 61f is positioned at the first linear portion 66a. The first linear portion 66a is provided with two bent portions 66g. The bent portion 66g linearly extends in the width direction of the first linear portion 66a. The first linear portion 66a is bent along the bent portion 66g to become the terminal 61a.

The support portion 61e of the first bus bar 61 is positioned at the base end portion 66c. The base end portion 66c is provided with a bent portion 66f. The base end portion 66c is belt along the bent portion 66f so that the first linear portion 66a is able to be raised in a direction perpendicular or substantially perpendicular to a surface of the support portion 61e.

The arm portion 61d and the connecting terminal portion 61b are positioned at the second linear portion 66b. That is, the connecting terminal portion 61b is positioned at the second linear portion. The second linear portion 66b is provided with a bent portion 66e. The bent portion 66e linearly extends in the width direction of the second linear portion 66b. The second linear portion 66b is bent along the bent portion 66e. In the second linear portion 66b, a tip side from the bent portion 66f defines the connecting terminal portion 61b and a base side from the bent portion 66f configures the arm portion 61d.

Moreover, in the present preferred embodiment, the support portion 61e is positioned at the base end portion 66c of the first metal plate 66, but the support portion 61e may be positioned at another position, if so desired. For example, the support portion 61e may be positioned at the first linear portion 66a.

Above, each portion of the first metal plate 66 is described, but each portion of the second metal plate 67 also preferably has similar configuration. As illustrated in FIG. 6, the second bus bar 62 includes a base end portion 67c, a first linear portion 67a and a second linear portion 67b respectively extending from the base end portion 67c in the same direction in a state of being unfolded (that is, the second metal plate 67). One end of the first linear portion 67a has a third linear portion 67d extending in a direction perpendicular or substantially perpendicular to the first linear portion 67a. Therefore, the second metal plate 67 has a U shape or approximate U shape, for example. In the second metal plate 67, the coil connecting portion 62f is positioned at the first linear portion 67a and the connecting terminal portion 62b is positioned at the second linear portion 67b. That is, the third linear portion 67d is bent along a bent portion 67f between the first linear portion 67a and the third linear portion 67d, and is bent in a U shape or approximate U shape along a bent portion 67g to define the terminal 62a. The connecting terminal portion 62b is preferably formed by being bent along a bent portion 67e, for example.

Since the first metal plate 66 and the second metal plate 67 respectively have the U shape or approximate U shape, an area of a base material necessary for punching the first metal plate 66 is able to be reduced. The first metal plate 66 and the second metal plate 67 are molded by punching. Since the first metal plate 66 and the second metal plate 67 have the U shape or approximate U-shape, vertical and horizontal dimensions become small. As a result, it is possible to increase the number taken from one sheet plate material. On the other hand, it is possible to reduce the remaining material left after punching the first and second metal plates 66 and 67 from the base material. Therefore, according to the present preferred embodiment, it is possible to reduce the cost for manufacturing the motor.

The bus bar holder 65 preferably is provided with three first through-holes 65A and three second through-holes 69 penetrating in the upward and downward direction, for example.

The first through-holes 65A are respectively positioned on the inside of the recessed portions 63 which are different from each other. The first through-hole 65A overlaps the terminals 61a and 62a of the coil connecting portions 61f and 62f. The coil end 43a passes through the first through-hole 65A and is connected to the coil connecting portions 61f and 62f. The first through-hole 65A is opened sufficiently large with respect to sizes of the coil connecting portions 61f and 62f. Therefore, even if there are some positional shift between the coil end 43a and the coil connecting portions 61f and 62f, the coil connecting portions 61f and 62f are able to be connected to the first through-hole 65A.

The second through-hole 69 is positioned at a center of the bus bar holder 65. The shaft 31 passes through the second through-hole 69. As illustrated in FIG. 1, a cylinder portion 69a extends to the lower side is disposed at an opening edge of the second through-hole 69. The cylinder portion 69a is fitted to the bearing holder through-hole 55g. Therefore, the bus bar assembly 60 is able to be aligned in a plane perpendicular or substantially perpendicular to the axial direction with respect to the bearing holder 55. In addition, the bus bar holder 65 is positioned in the circumferential direction by a portion (not illustrated) which is positioned with respect to the bearing holder 55 in the circumferential direction. Therefore, it is possible to enhance accuracy of alignment of the connecting terminal portions 61b and 62b of the bus bar assembly 60, and it is possible to smoothly insert the connecting terminal portions 61b and 62b into the socket 100a of the controller 100. In a state where the bus bar assembly 60 is positioned as described above, each coil end 43a is connected to the coil connecting portion 61f. Since the coil itself has rigidity, the bus bar assembly 60 does not move on the upper surface of the bearing holder 55. In addition, the bus bar holder 65 and the bearing holder 55 may be fastened by thermal welding, for example. That is, a projection is provided in the bus bar holder 65, the projection is inserted into the through-hole provided in the bearing holder 55, and a tip of the projection is thermally welded.

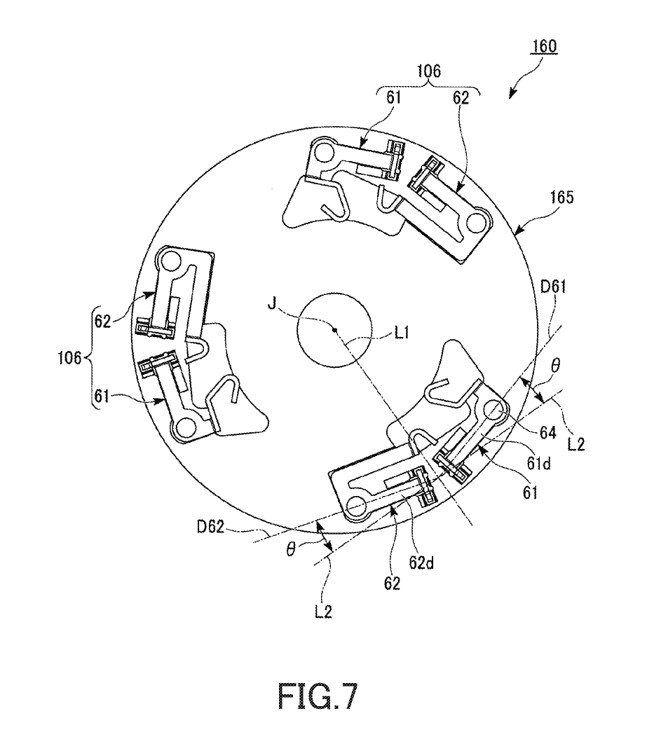

Next, a bus bar assembly 160 of Modification example 1 will be described with reference to FIG. 7. Moreover, the same reference numerals are given to the same configuration elements of the preferred embodiments described above, and the description thereof will be omitted.

FIG. 7 is a plan view of the bus bar assembly 160.

Compared to the preferred embodiments described above, in the bus bar assembly 160, the arrangement of a first bus bar 61 and a second bus bar 62 with respect to a bus bar holder 165 is mainly different.

The bus bar assembly 160 preferably includes three first bus bars 61, three second bus bars 62, and the bus bar holder 165. The shapes of the first bus bar 61 and the second bus bar 62 are the same as those of the preferred embodiments described above. In addition, similar to the preferred embodiments described above, the first bus bar 61 and the second bus bar 62 are paired and disposed in the bus bar holder 165. In the following description, in the bus bar assembly 160, the pair of the first bus bar 61 and the second bus bar 62 is referred to as a bus bar pair 106. The bus bar assembly 160 preferably includes six bus bar pairs 106, for example.

Similar to the preferred embodiments described above, the arm portions 61d of the first bus bar 61 and the second bus bar 62 extend in a direction perpendicular or substantially perpendicular to the radial direction in plan view. More specifically, the arm portion 61d extends in a range of about ±45 degrees with respect to a direction perpendicular or substantially perpendicular to the radial direction in plan view with an intermediate point CP as a start point.

The first bus bar 61 and the second bus bar 62 of the bus bar pair 106 are preferably disposed so that arm portions 61d and 62d are arranged in a V shape or approximate V shape in plan view in a plane perpendicular or substantially perpendicular to the axial direction. That is, in a pair of the bus bars 61 and 62 which is disposed closest to each other and configures the bus bar pair 106, a length direction D61 of one arm portion 61d and a length direction D62 of the other arm portion 62d are not parallel to each other. In FIG. 7, an angle θ defined between the length directions D61 and D62D of the arm portions 61d and 62d, and a second reference line L2 is 30 degrees or substantially 30 degrees. Therefore, it is possible to configure the compact bus bar assembly 160 while setting the arm portions 61d and 62d of the first bus bar 61 and the second bus bar 62 to be long.

As described above, the arm portions 61d and 62d are lengthened so that the mobility of the connecting terminal portion 61b can be enhanced and even in a case where the thermal expansion or the like occurs, it is possible to stably maintain the connection state. In addition, it is possible to smoothly insert the connecting terminal portion 61b and the controller 100 into the socket 100a. In a case where the dimension of the bus bar assembly 160 in the radial direction is limited, in order to make the arm portions 61d and 62d the longest, it is preferable that the length directions are respectively disposed perpendicular or substantially perpendicular to the radial direction. More specifically, it is preferable that the length directions of the arm portions 61d and 62d are perpendicular or substantially perpendicular to the radial direction with centers of the arm portions 61d and 62d as start points in the length directions. As illustrated in the modification example, the arm portions 61d and 62d of the bus bar pair 106 are preferably arranged in the V shape or approximate V shape and the first bus bar 61 and the second bus bar 62 are disposed, so that each of the arm portions 61d and 62d can be independently disposed in a direction in which it is easy to set a longer length. Therefore, it is possible to configure the compact bus bar assembly 160 by setting the arm portions 61d and 62d to be long.

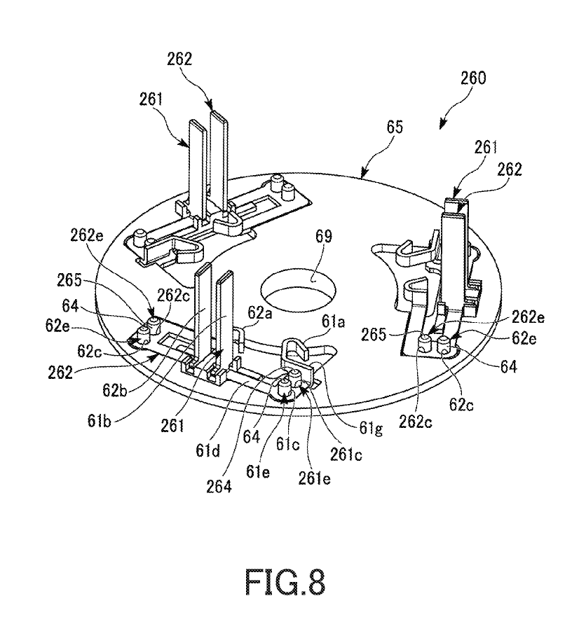

Next, a bus bar assembly 260 of Modification example 2 will be described with reference to FIG. 8. Moreover, the same reference numerals are given to the same configuration elements the preferred embodiments described above, and the description thereof will be omitted.

FIG. 8 is a perspective view of the bus bar assembly 260. Compared to the preferred embodiments described above, in the bus bar assembly 260, configurations of support portions of a first bus bar 261 and a second bus bar 262 are mainly different.

The first bus bar 261 preferably includes two support portions. That is, in addition to the support portion 61e in the preferred embodiments described above, a support portion 261e is provided at a coupling portion 61g. Similar to the support portion 61e, the support portion 261e is provided with a hole 261c penetrating in the upward and downward direction. A support protrusion 264 extending from an upper surface of the bus bar holder 65 to the upper side is inserted into the hole 261c. A tip of the support protrusion 264 is preferably thermally welded, for example. Moreover, in FIG. 8, a state before thermal welding of the support protrusion 264 is illustrated.

While the first bus bar 61 of the preferred embodiments described above is rotatable with the support portion 61e as a start point, the first bus bar 261 is supported by two support portions 61e and 261e on the bus bar holder 65 so that the first bus bar 261 does not rotate with respect to the bus bar holder 65. Therefore, the first bus bar 261 is able to be positioned with respect to the bus bar holder 65 by two support portions 61e and 261e. Therefore, the projection wall 63e and the side protruding portion 68b defining the rotation limiting portion of the preferred embodiment described above can be omitted.

In addition, the first bus bar 261 is supported on the bus bar holder 65 by the two support portions 61e and 261e so that the first bus bar 261 is able to be fixed to the bus bar holder 65. Since the connecting terminal portion 61b is supported via the arm portion 61d with the support portions 61e and 261e as start points, the arm portion 61d is able to be electrically deformed with the shaft the support portions 61e and 261e as starts points. Therefore, similar to the preferred embodiments described above, it is possible to smoothly insert the connecting terminal portion 61b into the socket 100a of the controller 100.

Similar to the first bus bar 261, the second bus bar 262 also preferably includes two support portions 62e and 262e. The support portion 262e has a hole 262c. A support projection 265 is inserted into the hole 262c and a tip is thermally welded. The other configurations and operational effects are the same as those of the first bus bar 261.

In addition, although the first bus bar 261 and the second bus bar 262 preferably include two support portions, the number of the support portions is not limited as long as positioning with respect to the bus bar holder is performed by the support portion.

Although the various preferred embodiments and modifications of the present disclosure are described above, the respective configurations and combinations thereof in the preferred embodiments and the modification examples are examples, and it is possible to adjust, omit, and substitute configurations, and other changes without departing from the spirit of the present disclosure. In addition, the present disclosure is not limited by the preferred embodiments.

For example, the bearing holder 55 may be positioned not only on the lower side but also on the upper side of the bus bar assembly 60. In addition, in the first bus bar 61 and the second bus bar 62, the coil connecting portions 61f and 62f are positioned on the inside in the radial direction, but may be positioned on the outside of the arm portions 61d and 62d in the radial direction.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-14. (canceled)

15: A motor comprising:
a rotor that includes a shaft centered on a central axis extending in an upward and downward direction;
a stator that is positioned to face the rotor; and
a bus bar unit that is positioned on an upper side of the stator and connects the stator to a control device,
wherein the bus bar unit includes a bus bar and a bus bar holder supporting the bus bar,
wherein the bus bar includes
a coil connecting portion that is connected to a coil end extending from the stator,
a connecting terminal portion that extends upward and is connected to the control device,
a support portion that is supported by the bus bar holder, and
an arm portion that is positioned between the support portion and the connecting terminal portion, and
wherein the arm portion extends in a direction intersecting a radial direction in plan view.

16: The motor according to claim 15,
wherein the coil connecting portion of the bus bar overlaps the arm portion in the radial direction.

17: The motor according to claim 15,
wherein the bus bar has one support portion and is rotatable with respect to the bus bar holder centered on the support portion in a plane orthogonal to the central axis.

18: The motor according to claim 17,
wherein the bus bar holder includes a rotation restricting portion that restricts rotation of the bus bar centered on the support portion.

19: The motor according to claim 15,
wherein, in the bus bar, the support portion is fixed to the bus bar holder, and the bus bar is not rotatable with respect to the bus bar holder centered on the support portion in a plane orthogonal to the central axis.

20: The motor according to claim 19,
wherein the bus bar includes two support portions.

21: The motor according to claim 15,
wherein the bus bar holder is made of an insulating material and includes a shaft portion and a head portion that is positioned at a tip of the shaft portion,
wherein the support portion of the bus bar is provided with a hole into which the shaft portion is inserted, and
wherein a diameter of the hole is larger than a diameter of the shaft portion and is smaller than a diameter of the head portion.

22: The motor according to claim 15,
wherein the bus bar holder is provided with a first through-hole which penetrates the bus bar holder in the upward and downward direction and through which the coil end passes, and
wherein the coil connecting portion is connected to the coil end on the upper side of the first through-hole.

23: The motor according to claim 15,
wherein the bus bar is made of a metal plate bent in a thickness direction,
wherein in an unfolded state, the metal plate has a U shape having a base end portion, and a first linear portion and a second linear portion respectively extending from the base end portion in the same direction, and
wherein the coil connecting portion is positioned at the first linear portion and the connecting terminal portion is positioned at the second linear portion.

24: The motor according to claim 15, further comprising:
a bearing that supports the shaft; and
a bearing holder that holds the bearing,
wherein the bearing holder is positioned on an upper side or a lower side of the bus bar unit, and is provided with a bearing holder through-hole through which the shaft passes,
wherein the bus bar holder is provided with a second through-hole through which the shaft passes, and
wherein an opening edge of the second through-hole is provided with a cylinder portion fitted in the bearing holder through-hole.

25: The motor according to claim 15, further comprising:
a cylindrical housing that houses the stator and includes an opening on an upper side,
wherein the opening of the housing is provided with a control device housing region capable of housing at least a part of the control device, and
wherein the bus bar unit is positioned on a lower side of the control device housing region.

26: The motor according to claim 15,
wherein the bus bar unit includes a plurality of the bus bars, and
wherein in a pair of the bus bars disposed closest to each other among the plurality of the bus bars, the arm portions are arranged linearly with each other in a plane orthogonal to the axial direction.

27: The motor according to claim 15,
wherein the bus bar unit includes a plurality of the bus bars, and
wherein in a pair of the bus bars disposed closest to each other among the plurality of the bus bars, the arm portions are arranged in a V shape in plan view with each other in a plane orthogonal to the axial direction.

28: The motor according to claim 15,
wherein the arm portion of the bus bar extends in a range of 45 degrees with respect to a direction orthogonal to the radial direction in plan view.
